(19) United States
(12) Patent Application Publication
(10) Pub. No.: US 2018/0373603 A1
(43) Pub. Date: Dec. 27, 2018

(54) Web Application System and Database Utilization Method Therefor

(71) Applicant: Satoshi INAGE, Kyoto (JP)

(72) Inventor: Satoshi INAGE, Kyoto (JP)

(21) Appl. No.: 15/574,206

(22) PCT Filed: Jan. 23, 2017
(86) PCT No.: PCT/JP2017/002112

§ 371 Date: Nov. 15, 2017

(30) Foreign Application Priority Data
Feb. 1, 2016 (JP) 2016017046

(51) Int. Cl. G06F 11/14; G06F 17/30

(52) U.S. Cl. CPC G06F 11/1469; G06F 2201/84; G06F 17/30306; G06F 11/1464

(57) ABSTRACT

By a user logging in to a web application system, a database is created on a database server 20 utilized through a web application server 10, data in the database is restored from backup data in a client terminal 30, operation logs for data entry, modification, and deletion by means of a web application are created in the client terminal 30, and upon logout, backup data of the database is saved from the database server 20 to the client terminal 30 before the database is deleted from the database server 20.

### TECHNICAL FIELD

The present invention relates to a web application system and a database utilization method therefor, in which the web application system includes a web application server connected to a client terminal via a network and a database server with a database connected to the web application server, and the web application system and the database utilization method aim to enhance data protection for the database.

### BACKGROUND ART

The usage and the access procedures of databases are defined in detail in the form of specifications. When a database is utilized, it is necessary to establish a connection to a database server in accordance with the manuals for the database before connection to the database. The method for utilizing the database defines a detailed utilization procedure so as not to confuse any users upon utilization of the database, and therefore, a web application system can be developed such that any users can readily utilize the database. Typical examples of information required for utilizing a standard database are a database server name, a database name, a user ID, and a password. Once the database server name, the database name, the user ID, and the password are known, the database can be operated freely regardless of whether the user is an authorized database user or not. Moreover, the database always exists on the database server on the internet regardless of whether the database is being accessed or not, and therefore, there is no time when it is physically impossible to access the database.

Referring to Patent Document 1, it is clearly indicated that user authentication is performed to allow database utilization, but there are no descriptions clearly indicating or specifying the name and the time of creation of a database on a database server, and therefore, as can be appreciated from Patent Document 1, it is presumably premised that the database exists invariably when the web application system is in operation. In such circumstances, improper acquisition of a user ID, a database name, a database server name, and a password, which are required for accessing a database, allows free access to the database, with the result that the protection of the database is virtually compromised.

### PRIOR ART DOCUMENT

### Patent Document

Patent Document 1: Japanese Laid-Open Patent Publication No. 2013-122660

### DISCLOSURE OF THE INVENTION

### Problems to be Solved by the Invention

The present invention provides a web application system and a database utilization method which allow the database to be dynamically created and erased and also allow a database name, among other pieces of information required for accessing the database, to be dynamically operated and managed, with the result that data in the database can be protected even if a user ID, a password, and a database server name, which are required for accessing the database, are acquired illegally.

### Solution to the Problems

Therefore, in the present invention, the database is created on the database server on the internet in accordance with the database user's operation of logging in to the web application system, and data for the database in a terminal being operated by the user is automatically reentered to the database on the basis of that data and, if necessary as a result of judging the state of the database at the time of the last closing of the database, data for operation logs of the database, thereby restoring the database to the state immediately before the user finished utilizing the database, with the result that the user can utilize the database through the web application. While the user is utilizing the web application system, operation logs of all operations performed on the database for data entry, modification, and deletion are saved to the terminal being operated by the user, as data available for restoring the database. With the completion of the user's utilization of the web application, the user logs out of the web application system, thereby erasing the database from the database server on the internet. In this case, prior to the erasing of the database in the current state, all data entered in the database is saved to the terminal being operated by the user, as data that can be reentered in the database. By succeeding in this process, the data up to this point is determined to have been reflected in the database, and the operation log data for the database is erased.

Once the database is created on the database server, the time of creation of the database is recorded, and thereafter, the database is monitored for a period of time during which the database is not being operated. Moreover, if the database is determined to not have been operated even after a lapse of a predetermined period of time being set for the database, the utilization of the database is considered to have been finished, and the database is forcibly erased. In this case, the contents of the database are not saved to the user terminal.

The operation log data for the database, which is generated during the utilization of the web application, and all data for the contents of the database, which is saved at the time of logout as a result of the utilization of the web application being finished, do not exist on the server on the internet and are always saved to the terminal being operated by the user, i.e., saved locally. Accordingly, when the web application is not being utilized, none of the aforementioned data exists on the internet.

### Effect of the Invention

The present invention allows time during which no database physically exists on the database server. Moreover, the database name required for accessing the database changes upon every database creation. Thus, to successfully gain unauthorized access, it is necessary to acquire a user ID, a password, and a database server name, which are pieces of information conventionally required for database access, and further, it is also necessary to know the time during which the database physically exists and acquire a database name valid for access in each case, and therefore, the present invention achieves the effect of enhancing security against unauthorized access to the database.

### BRIEF DESCRIPTION OF THE DRAWINGS

FIG. 1 is a diagram illustrating a general configuration of a web application system according to an embodiment.

FIG. 2 is a flowchart showing a procedure of creating a database in the embodiment.

FIG. 3 is a flowchart showing a procedure of accessing the database in the embodiment.

FIG. 4 is a flowchart showing a procedure of erasing the database in the embodiment.

FIG. 5 is a flowchart showing the procedure of monitoring the time during which the database exists.

### MODE FOR CARRYING OUT THE INVENTION

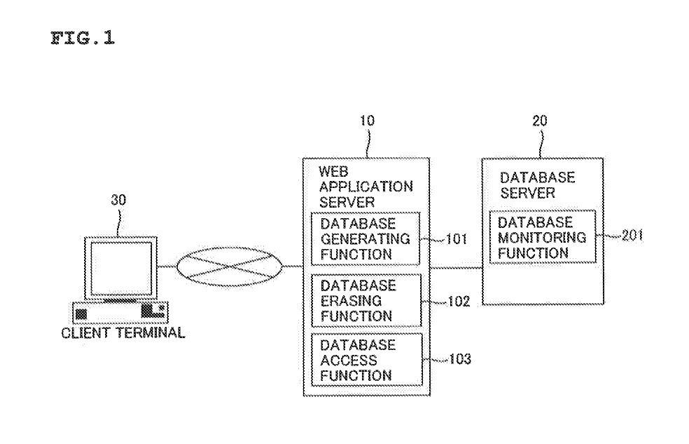

Hereinafter, an embodiment of the present invention will be described in detail with reference to the drawings. FIG. 1 illustrates a general configuration of an embodiment of the present invention. A web application system based on the present invention includes a web application server 10, a database server 20, and a client terminal 30 operated by a user and connected to the web application server 10 via a network. The web application server 10 has a database generating function 101, a database erasing function 102, and a database access function 103, and the database server 20 has a database monitoring function 201. The client terminal 30 connected via the network has database backup data and operation logs.

The database generating function 101 is executed after successful user authentication for logging in to the web application system, in order to create the name of a database and the database itself, perform authority settings for the database, and thereafter restore data to the database based on the backup data and the operation logs saved in the client terminal 30, thereby restoring the database to the state immediately before the user's last logout. When the web application system accesses the database, the database access function 103 updates the database, creates operation logs for the database, and saves the operation logs to the client terminal 30. When the user logs out, the database erasing function 102 is executed prior to the logout, in order to execute a backup of the database and save the backup to the client terminal 30, and when the backup is successful, the operation logs are erased, and thereafter, the database is erased from the database server 20. The database monitoring function 201 monitors the time during which the database is not being operated after the generation of the database on the database server 20, and when a predetermined expected lapse time is exceeded, the database is erased from the database server 20. The database monitoring function 201 has no database backup functionalities.

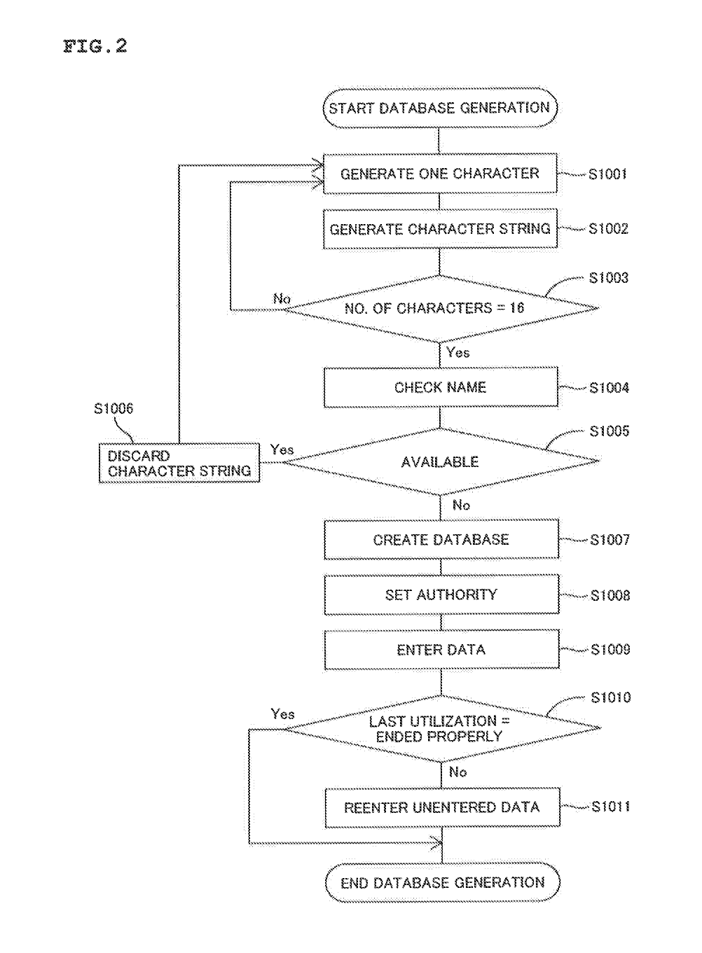

FIG. 2 is a flowchart showing the procedure for the database generating function 101 executed on the web application server 10 after successful user authentication for the web application system. The database generating function 101 includes the process from S1001 to S1003 for creating a database name to be used one time only, the process at S1007 and S1008 for actually creating a database with the database name, and the process at S1009 for entering data in the created database.

At S1001, one character of a database name is randomly determined, and at S1002, another character is added to the database name. Upon the first execution of S1001 after the database generating function 101 is called up from the web application system, a character string for the database name is blank, and therefore, one character is added to the blank character string. Accordingly, the character is the initial letter of the current database name to be used. Next, on the basis of the number of characters in the database name put together by S1002, termination conditions for S1001 and S1002 are determined (S1003). Once the number of characters in the database name reaches 16, the repetition from S1001 to S1002 is terminated (S1003). At S1004, it is checked to ensure that the database name that is currently being created has not yet existed on the database server 20 nor is the name the same as the last database name created by the database generating function 101, and then it is determined whether the database name created by S1004 is available (S1005). When the determination result at S1005 turns out to be positive, the procedure advances to S1007. At S1007, a database is created with the database name, and thereafter, at S1008, authority settings for the created database are made, thereby rendering the database in the same state as databases utilized in conventional operation methods.

Upon completion of S1008, the database created with the database name is available for use in a conventional manner, but at this stage, no data has yet been entered, i.e., the database is empty. Data is entered in the database at S1009 where the operation of entering data in the database created on the database server 20 is performed using the database backup data saved in the client terminal 30 being operated by the user. Next, in this state, it is determined whether all data has been entered in the new database (S1010), and this determination is made on the basis of whether there is any operation log created by the user performing data entry, modification, or deletion on the database. When there is any remaining operation log, it is determined that some data is left unentered because the last database utilization did not end properly, and on the basis of operation logs in the client terminal 30 being operated by the same user, the data that remains unreflected is entered in the database on the database server 20, by means of the web application server 10. By the process at S1011 being completed properly, the database is rendered in a properly usable state, and the database generating function 101 ends.

FIG. 3 shows a flowchart for the database access function 103 where the web application system utilizes the database created by the database generating function 101. The procedure is called up when the web application system performs data entry, modification, or deletion on the database; at S2001, data is received from the web application system through which the database is operated, and data entry, modification, or deletion is performed on the database in accordance with a database operation command. It is determined whether the command provided to the database was successfully executed (S2002), and if the execution is unsuccessful, the cause of error and the command are returned to the web application system as a result of a database operation error (S2004). When the execution is successful, an operation log is transmitted and saved to the client terminal 30 being operated by the user, and the result is returned to the web application system as success (S2003). This process is executed only when the contents of the database have been changed, and no operation log is recorded for operations such as reference and inquiry. Reference and inquiry commands by so-called SELECT statements do not involve changes to data, and therefore, the database access function 103 is not executed for such commands.

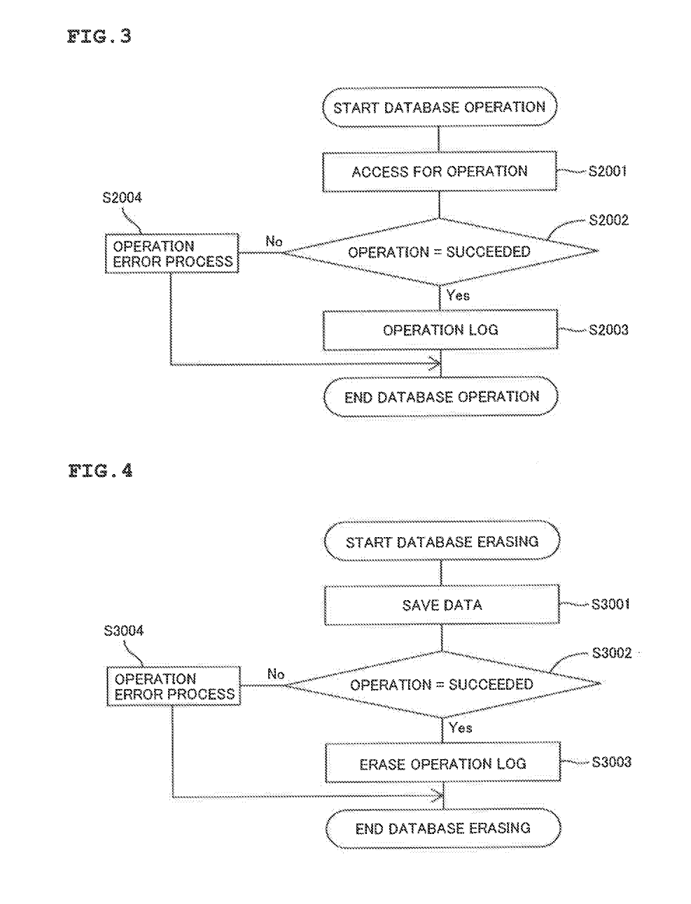

FIG. 4 illustrates a flowchart for the database erasing function, which is a procedure executed when the user logs out of the web application system, so as to erase the database from the database server 20. Once the database erasing function 102 is called up from the web application system, initially at S3001, a backup is created for all data in the current database to be erased. It is determined whether the data backup is completed (S3002). If the backup is properly completed, operation logs in the client terminal 30 are erased at S3003. In this case, if the backup is not properly completed, the operation logs in the client terminal 30 are not erased, and the cause of error is returned to the web application system by an operation error process (S3004).

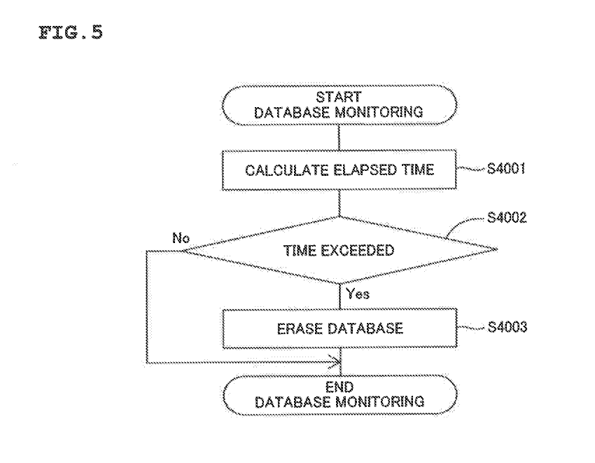

FIG. 5 shows a flowchart for the database monitoring function 201 for determining the time elapsed since creation of a database by the database generating function 101 and erasing the database if a designated period of time has already elapsed. At S4001, the time elapsed since the creation of the database is calculated. It is determined whether the elapsed time calculated at S4001 has already exceeded the designated period of time (S4002). If the designated period of time has not yet been exceeded, the database monitoring function 201 ends without erasing the database. If the designated period of time has already been exceeded, the database is erased from the database server 20 (S4003).

### INDUSTRIAL APPLICABILITY

In the present invention, a database is created or erased upon the user's login or logout, and therefore, when a system which only allows limited users to utilize data as in accounting, cash book management, or estimate/invoice management is constructed as a web application system, it is conceivable that the present invention is used with a view to improving data protection for the database and data independence from one user to another.

### DESCRIPTION OF THE REFERENCE CHARACTERS

10 web application server
20 database server
30 client terminal
101 database generating function
102 database erasing function
103 database access function
201 database monitoring function

1. A web application system comprising:
a web application server connected to a client terminal via a network; and
a database server with a database connected to the web application server, wherein,
the web application system has functions of:
creating a database on the database server by a user logging in to the web application system, and restoring data to the database from backup data of the database saved in the client terminal, thereby allowing data entry, modification, deletion, and reference to be performed on the database by the web application system;
upon logout, saving the data in the database to the client terminal and deleting the database from the database server, and
when the database continues to not be operated for a given period of time or more, automatically deleting the database from the database server.

2. The web application system according to claim 1, wherein the database is created using a name being created differently upon each login, provided that, upon the creation of the database, the name is not the same as a name existing on the database server nor a name of the database created last time.

3. The web application system according to claim 1, having a function of creating an operation log in the client terminal upon an operation of data entry, deletion, or modification on the database, so as to prepare against data corruption upon failure of the database.

4. A database utilization method for a web application system including a web application server connected to a client terminal via a network and a database server with a database connected to the web application server, wherein the database utilization method comprises the steps of:
creating a database on the database server by a user logging in to the web application system and thereafter restoring data to the database from backup data of the database saved in the client terminal;
upon logout, saving the data in the database to the client terminal and thereafter deleting the database from the database server, and
when the database continues to not be operated for a given period of time or more, automatically deleting the database from the database server.
